(19) United States
(12) Patent Application Publication
(10) Pub. No.: US 2023/0367144 A1
(43) Pub. Date: Nov. 16, 2023

(54) INTEGRATED METASURFACES FOR FREE-SPACE WAVEFRONT GENERATION WITH COMPLETE AMPLITUDE, PHASE, AND POLARIZATION CONTROL

(71) Applicant: THE TRUSTEES OF COLUMBIA UNIVERSITY IN THE CITY OF NEW YORK, New York, NY (US)

(72) Inventors: Nanfang Yu, Fort Lee, NJ (US); Andrea Alu, Tenafly, NJ (US); Heqing Huang, New York, NY (US); Yuan Xu, New York, NY (US); Adam Overvig, Bronx, NY (US)

(73) Assignee: THE TRUSTEES OF COLUMBIA UNIVERSITY IN THE CITY OF NEW YORK, New York, NY (US)

(21) Appl. No.: 18/318,231

(22) Filed: May 16, 2023

Related U.S. Application Data
(60) Provisional application No. 63/342,475, filed on May 16, 2022.

(51) Int. Cl. G02F 1/01; G02B 6/122; G02B 1/00; B82Y 20/00

(52) U.S. Cl. CPC G02F 1/0113; G02F 1/0139; G02B 6/1223; G02B 6/1228; G02B 6/1225; G02B 1/005; B82Y 20/00; G02B 2006/12085

(57) ABSTRACT

The disclosed matter provides integrated metasurface devices for conversion between a waveguide mode and a free-space optical wave with a designer wavefront. In exemplary embodiments, the integrated metasurface devices include a thin waveguide, a waveguide taper, a leaky-wave metasurface defined within a high refractive index layer of dielectric material, and a low refractive index substrate. The device can manipulate all the four optical degrees of freedom of the free-space wavefront, namely: amplitude, phase, polarization orientation, and polarization ellipticity, by using a leaky-wave metasurface composed of meta-units with four structural degrees of freedom.

### CROSS-REFERENCE TO RELATED APPLICATION

This Non-Provisional application claims priority to U.S. Provisional Patent Application Nos. 63/342,475, which was filed on May 16, 2022, the entire contents of which are incorporated by reference herein.

### GRANT INFORMATION

This invention was made with government support under grant number EMPD-2004685 awarded by the National Science Foundation (NSF). The government has certain rights in the invention.

### BACKGROUND

Integrated metasurfaces can be used to modify a projected wavefront in a variety of ways. These modifications can include guided mode conversion, free-space to guided mode coupling, and free-space wavefront generation.

However, certain metasurfaces can only provide a limited (usually 1 to 2) optical degrees of freedom, based upon the structural degrees of freedom provided by a meta-unit. As a result, such metasurfaces can only manipulate optical degrees of freedom of an equal number or less (for example only phase or only amplitude) as its structural degrees of freedoms. Certain integrated metasurfaces have generated free-space wavefronts that are extensive in two dimensions. For example, they can control one or two structural degrees of freedom in a meta-unit, and can manipulate optical degrees of freedom of an equal number or less, e.g., only phase or amplitude.

As such, there is a need in the art for designing an improved integrated metasurfaces which can manipulate all the four optical degrees of freedom, which can allow for the manipulation of amplitude, phase, polarization orientation, and polarization ellipticity.

### SUMMARY

The disclosed subject matter provides integrated metasurfaces devices and methods for conversion between a waveguide mode and a free-space optical wave with a designer wavefront.

An example device includes a thin waveguide, a waveguide taper, a leaky-wave metasurface defined within a high refractive index layer of dielectric material, and a low refractive index substrate. In certain exemplary embodiments, the thin waveguide supports a waveguide mode, and the waveguide taper converts the waveguide mode into a slab waveguide mode in the form of a sheet of light. In certain exemplary embodiments, the leaky-wave metasurface comprises a plurality of meta-units. In certain exemplary embodiments, each meta-unit comprises two sets of anisotropic meta-atoms wherein the two sets have a subwavelength offset between each other, have different magnitudes of perturbation, and have different orientations of perturbation.

In certain exemplary embodiments, the slab waveguide mode is decomposed into two orthogonal standing waves, wherein the two sets of meta-atoms independently control the two standing waves, converting each standing wave into a surface emission with independent amplitude and polarization orientation. In certain exemplary embodiments, the two surface emissions merge into a single free-space wave with completely and independently controllable amplitude, phase, polarization orientation, and polarization ellipticity at each point over the wavefront of the free-space wave.

In certain exemplary embodiments, the high refractive index layer comprises one or more layers and the leaky-wave metasurface is defined within one or more of these layers. In certain exemplary embodiments, the meta-atoms are ellipse-shaped, the magnitude of perturbation is the ellipticity of the ellipse, and the orientation of perturbation is the angular orientation of the ellipse. In certain exemplary embodiments, the meta-atoms are rectangle-shaped, the magnitude of perturbation is the ratio between the long and short edges of the rectangle, and the orientation of perturbation is the angular orientation of the rectangle.

In certain exemplary embodiments, the meta-atoms are air apertures etched in the high refractive index layer. In certain exemplary embodiments, the meta-atoms are dielectric pillars etched in the high refractive index layer. In certain exemplary embodiments, the high refractive index layer comprises silicon, silicon nitride, silicon-rich silicon nitride, titanium dioxide, SU-8, and polymethyl methacrylate (PMMA), and the low refractive index substrate comprises silicon dioxide, calcium fluoride, and magnesium fluoride.

The disclosed matter also provides methods for converting a waveguide mode into a free-space optical wave with a designer wavefront. An example method includes converting the waveguide mode into a slab waveguide mode using a waveguide taper, coupling the slab waveguide mode into a leaky-wave metasurface, decomposing the slab waveguide mode within the leaky-wave metasurface into two orthogonal standing waves that are 90-degree out of phase, using the two sets of meta-atoms of the leaky-wave metasurface to independently convert the two standing waves into two surface emissions with independently controllable amplitude and polarization orientation, and merging the two surface emissions into a single free-space wave with completely and independently controllable amplitude, phase, polarization orientation, and polarization ellipticity at each point over the wavefront of the free-space wave.

The disclosed matter also provides methods for converting a free-space optical wave with a designer wavefront into a waveguide mode. An example method includes decomposing the free-space wave into two free-space components that are 90-degree out of phase, using the two sets of meta-atoms of the leaky-wave metasurface to independently convert the two free-space components into two orthogonal standing waves that are within the leaky-wave metasurface, combining two orthogonal standing waves into a slab waveguide mode, and coupling the slab waveguide mode into a waveguide mode using a waveguide taper.

The disclosed matter also provides for utilization of an integrated metasurface device for free-space wavefront generation. The utilization includes establishing a free-space wave with a designer polarization state, such as circular polarization, radial polarization, and azimuthal polarization, establishing a focused beam in free space, establishing a one-dimensional, two-dimensional, or three-dimensional array of focal spots in free space, establishing a vortex beam with orbital angular momentum in free space, establishing one or more holographic images in free space, and establishing a Poincare beam in free space.

In certain exemplary embodiments, the utilization includes incorporating the integrated metasurface device into integrating with AR/VR displays, and wearable devices, optical communications chips, optogenetic probes, and quantum optics setups.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Reference will now be made in detail to the various exemplary embodiments of the disclosed subject matter, which are illustrated in the accompanying drawings. The accompanying drawings, where like reference numerals refer to identical or functionally similar elements throughout the separate views, serve to further illustrate various embodiments and to explain various principles and advantages all in accordance with the disclosed subject matter.

FIG. 1a provides a schematic image of the integrated metasurface device in an embodiment of the disclosed subject matter. FIG. 1b provides a schematic image of dimerization perturbation for nonlocal metasurface in an embodiment of the disclosed subject matter. FIG. 1c provides a schematic image of an embodiment of the disclosed subject matter.

FIG. 2a-2f illustrates the simulation results of an exemplary meta-unit library in an embodiment of the disclosed subject matter.

FIG. 3a-3b illustrates an exemplary configuration for metasurface structures and internal layer structure of the metasurface device in an embodiment of the disclosed subject matter. FIG. 3c-3d provides a microscope image and scanning electron microscopy (SEM) image of the metasurfaces device in an embodiment of the disclosed subject matter.

FIG. 4 provides a demonstration for generating a radially polarized wavefront, converging beam, and simultaneous generation of a Vortex beam in interference with a tilted Gaussian beam, 2-Hologram, 4-Hologram, and Poincare beam in an embodiment of the disclosed subject matter.

FIG. 5 provides an illustration for generating a radially polarized wavefront in an embodiment of the disclosed subject matter.

FIG. 6a-6b provides an illustration for generating a converging or focusing beam in an embodiment of the disclosed subject matter.

FIG. 7a-7b provides an illustration for generating a Vortex beam and Gaussian beam in an embodiment of the disclosed subject matter.

FIG. 8a-8b provides an illustration for 2-Hologram demonstration in an embodiment of the disclosed subject matter.

FIG. 9a-9d provides an illustration for 4-Hologram demonstration in an embodiment of the disclosed subject matter.

FIG. 10a-10c provides an illustration of Poincare demonstration in an embodiment of the disclosed subject matter.

FIG. 11a-11d provides an illustration of generation of a two-dimensional array of optical spots following a Kagome lattice pattern in an embodiment of the disclosed subject matter.

It is to be understood that both the foregoing general description and the following detailed description are exemplary and are intended to provide further explanations of the disclosed subject matter.

### DETAILED DESCRIPTION

The subject matter provides techniques for integrated metasurfaces for free-space wavefront generation with amplitude, phase, and polarization control.

For clarity, but not by way of limitation, the detailed description of the disclosed subject matter is divided into the following subsections:

I. Definitions

II. Devices

III. Experimental Demonstration

### I. Definitions

As used herein, the term “metasurface” refers to typically flat, thin-film structures that can be integrated with other optical or electronic components to create compact, high-performance devices for a wide range of applications, including imaging, sensing, communication, and quantum optics. Generally, an integrated metasurface is a flat, thin device that can generate or manipulate free-space wavefronts using an array of sub-wavelength optical elements called meta-units.

As used herein, the term “wavefront” refers to an imaginary surface that connects all the points of a wave that are in the same phase or have the same phase difference. In other words, it is a surface that represents the position of the crest or trough of a wave at a given instant in time. By controlling the shape of a wavefront, the behavior of light can be manipulated to create certain optical effects, such as focusing, imaging, holography, or aberration correction.

As used herein, the term “free-space wavefront” refers to the spatial distribution of the electromagnetic field in free space, where there are no physical boundaries or constraints that would alter the propagation of light waves. In other words, a free-space wavefront represents the shape, amplitude, phase, and polarization of an optical wave as it propagates through the air or vacuum. It can be desirable to control or manipulate the properties of free-space wavefronts in order to achieve specific optical functions, such as imaging, holography, or beam shaping.

As used herein, the term “meta-units” refers to artificially created structures that exhibit unique electromagnetic properties due to their physical characteristics. Meta-units can be made up of subwavelength metallic or dielectric materials, sculptured into a precise geometric shape. These shapes can lead to specific interactions with incident electromagnetic waves, and can allow the meta-units to manipulate the phase, amplitude, and/or polarization of the waves in specific ways.

As used herein, the term “optical degrees of freedom” refers to the different properties of light that can be controlled and manipulated to achieve specific functions or applications. There are some main optical degrees of freedom, including: amplitude, phase, polarization orientation, and polarization ellipticity. The ability to control these optical degrees of freedom can be important in certain applications such as optical communications, sensing, imaging, and quantum optics. Metasurfaces can control all four degrees of freedom simultaneously, allowing for control over the behavior of light and enabling applications in photonics.

As used herein, the term “dimerized perturbation” refers to a perturbation or disturbance that causes a regular and periodic system to break its symmetry and form a pattern in which certain particles or subunits are grouped together in pairs, or dimers.

### II. Devices

The disclosed subject matter provides an integrated metasurfaces device which can manipulate the four optical degrees of freedom, namely: amplitude, phase, polarization orientation, and polarization ellipticity, by using a composite meta-unit with four structural degrees of freedom. Such device can generate free-space wavefront with complete amplitude, phase, and polarization control.

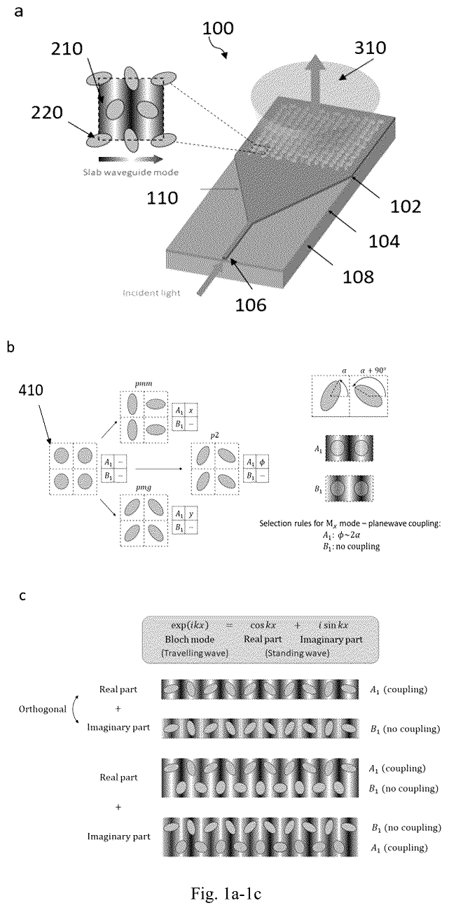

FIG. 1a illustrates a schematic device architecture of an exemplary integrated metasurfaces device 100. The device 100 is composed of at least three structure layers: a high refractive index layer 104, where a metasurface structure 102 can be patterned; the high refractive index layer 104 as the core of a waveguide, which is deposited on a low refractive index substrate 108. Light is incident from a narrow waveguide 106, then passes through a taper (slab waveguide 110) to form a wide slab waveguide mode that is extensive in two dimensions and finally coupled into free-space wavefront 310 through the metasurface pattern. A zoom-in of one exemplary meta-unit 210 is shown on the top-left, which is composed of four ellipse-shaped meta-atoms 220: two in the center, one in the corner, and one on the side.

As shown in FIG. 1b, a working principle of certain exemplary devices according to the disclosed subject matter can be based on the so-called “nonlocal metasurfaces.” As embodied herein, nonlocal metasurfaces refer to a type of metamaterial made up of artificially designed subwavelength structures, such as meta-units, that are arranged in a specific planar array. Such nonlocal metasurfaces exhibit nonlocal response, meaning that their electromagnetic properties depend not only on the local electric and magnetic fields but also on the nonlocal fields from nearby points in space. For traditional metasurfaces, the response of each meta-atom is assumed to be independent of the others, and the overall response of the metasurface can be calculated as a simple sum of the individual responses. However, in nonlocal metasurfaces in the disclose subject matters, the interaction between neighboring meta-atoms can significantly affect the overall response, leading to more complex and effective behavior.

In the disclosed subject matter, nonlocal metasurfaces can be useful for manipulating incident light at the nanoscale, where traditional optical materials and devices cannot operate effectively. By controlling the geometry and arrangement of the meta-units, it is possible to create metasurfaces with a wide range of optical properties, such as phase modulation and polarization conversion.

As shown in FIG. 1b, starting from a photonic crystal slab of a square lattice 410, when a dimerized perturbation with specific space-group symmetry is applied to the structure, a photonic crystal bound mode can be coupled to free-space radiation modes with distinct polarizations. As embodied herein, p2 symmetry can be used, where the first birefringent perturbation is orientated in an arbitrary angle α, and the second one is rotated 90 degrees from the first one. The selection rules for the A₁ and B₁ representations of the Mₓ mode are listed. It is found that for the A₁ representation, the polarization angle ϕ for the coupled free-space planewave is approximately two times the structural orientation angle α, while for the B₁ representation there is no coupling to planewaves. A “nonlocal metasurface” has been made based on the following principles, where a spatially varying perturbation strength and orientation angle locally can control the amplitude and polarization angle of the coupled free-space wavefront, or the polarization angle can be further converted into a geometric phase for a circularly polarized wavefront.

As illustrated in FIG. 1c, the operating modes of nonlocal metasurfaces are standing waves, whereas an integrated metasurface is fed with a waveguide mode, which is a travelling wave. This travelling wave, in the form of a Bloch mode, can be decomposed into its real part and imaginary part, each in the form of a standing wave. These two components are shifted by a quarter period along the propagation direction and being orthogonal to each other. A row of meta-atoms with proper placement will see the real part component as an A₁ representation, as shown in the FIG. 1c, and see the imaginary part component as a B₁. If a second row of meta-atoms is added, a quarter period shifted from the first row, as shown in the bottom two illustrations, the second row can present the real part as a B₁ representation, and the imaginary part as an A₁ representation.

According to the selection rules, a mode of A₁ representation couples to free-space, while the B₁ representation does not couple. Therefore, the real part component couples to free-space only through the first row of perturbation, and the imaginary part couples only through the second row. As a result, the two rows of meta-atoms independently couple the two components of the guided mode into free-space, each with a controllable amplitude and polarization angle. In addition, because the real part and imaginary part are 90 degrees different in phase, all the four degrees of freedom of the complex vectoral free-space wavefront can be controlled, namely the real and imaginary parts of the x and y polarization components.

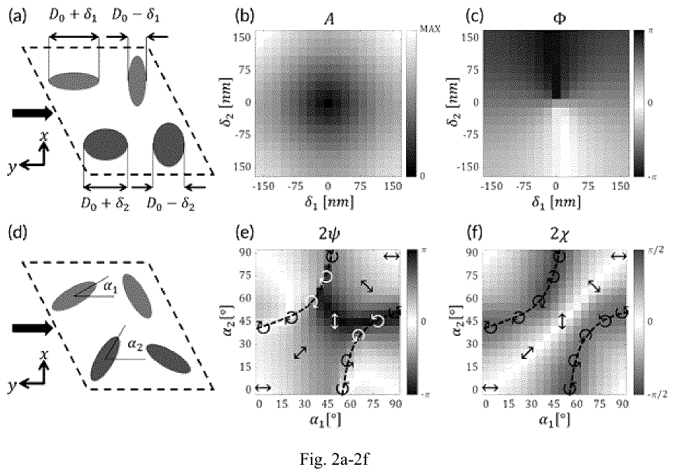

FIG. 2a-2f show properties of the meta-unit library according to full-wave simulations. FIG. 2a shows that for fixed elliptical orientations, the perturbations 61 and 62 determine the signed magnitude of the real and imaginary parts of the scattered field, respectively. FIG. 2b is a simulated map of scattered amplitude of y-polarized light as a function of δ₁ and δ₂, showing a bound state when both perturbations vanish. FIG. 2c is a simulated map of scattered phase of y-polarized light as a function of δ₁ and δ₂, supporting a topological feature characteristic of a geometric phase. FIG. 2d shows that for fixed δ₁ and δ₂, the perturbation angles α₁ and α₂ determine the polarization state scattered by the unit cell. FIGS. 2e and 2f are simulated maps of 2ψ and 2× as a function of α₁ and α₂, with dashed contours denoting chiral states near the poles of the Poincaré sphere. Arrows denoting the approximate polarization states are overlaid for reference.

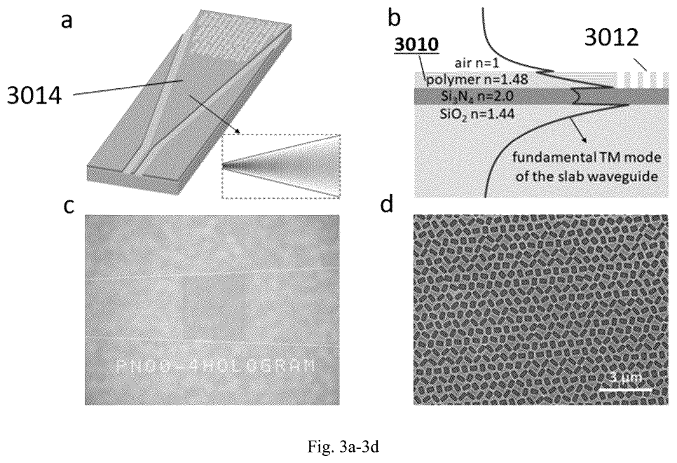

FIG. 3a-3d illustrate an exemplary configuration according to the disclosed subject matter. Both the metasurface structures and the waveguide circuit can be defined in a polymer layer 3010 of a positive e-beam resist using e-beam lithography, as shown in FIG. 3a and FIG. 3b. The metasurface 3012 is directly placed in a long linear waveguide taper 3014. A microscope image of FIG. 3c shows a fabricated device 400 μm in size. An SEM image in FIG. 3d shows the meta-atoms of a fabricated device.

### III. Experimental Demonstration

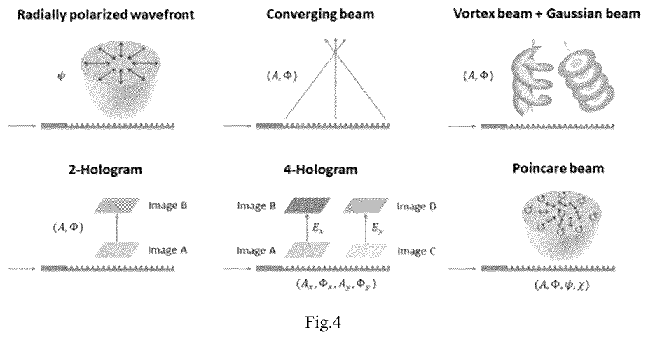

As embodied herein, experimental demonstrations of six exemplary devices are provided, operating at the wavelength of 1.55 um, using the above platform. As shown in FIG. 4, namely, a Radially polarized wavefront, a Converging beam, a device generating simultaneously a Vortex beam in interference with a tilted Gaussian beam, a 2-Hologram device, which generates two images in the near-field and far-field, respectively, a 4-Hologram device, where the x and y polarization components each generates two images in the near-field and far-field, respectively, and finally, a Poincare beam, which contains all the 2-dimensional polarization states on a corresponding wavefront.

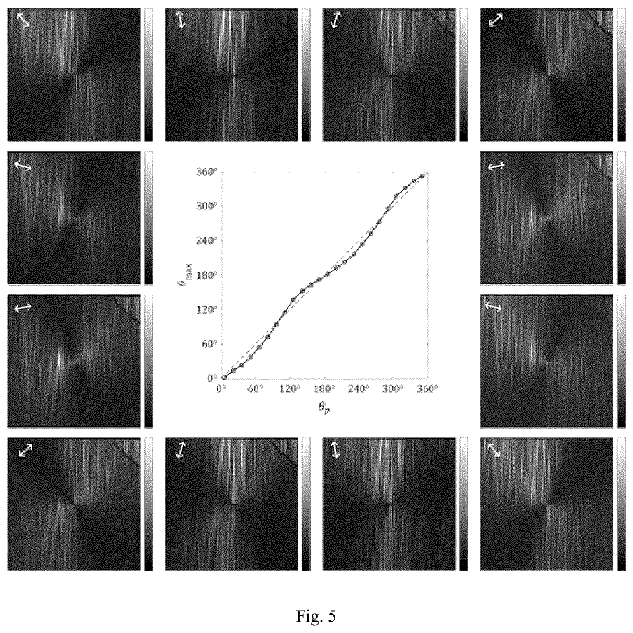

FIG. 5 illustrates a device generating a radially polarized wavefront to demonstrate polarization orientation control. Border panels show measured intensity profiles at the metasurface plane while varying the orientation θₚ of a polarization analyzer. The center panel shows computed best-fit angle θₘₐₓ for each experiment θₚ, showing excellent agreement with the ideal case (dashed line).

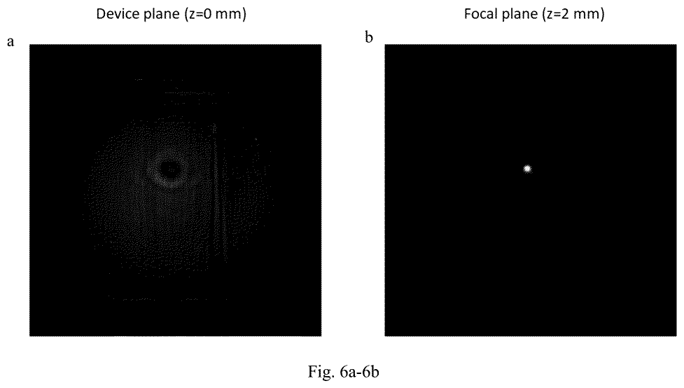

FIG. 6a-6b illustrates an exemplary device generating a converging beam can be demonstrated, by properly setting the phase profile and a smooth amplitude envelope. The image on the left (FIG. 6a) is taken on the device plane, and the image on the right (FIG. 6b) is taken on the focal plane. As shown in these illustrations, a bright focal spot is formed at the designed focal distance.

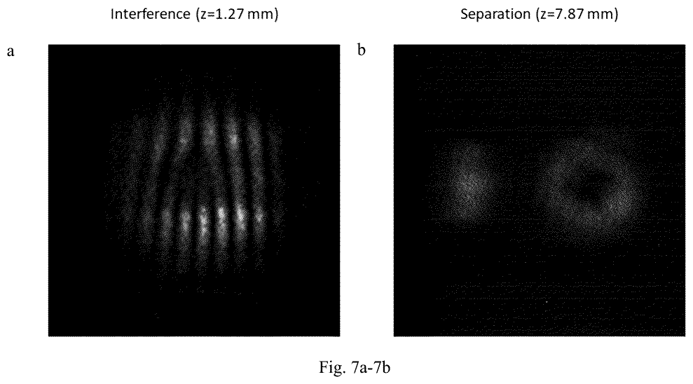

FIG. 7a-7b illustrates an exemplary device with a complex profile, which generates a Vortex beam in interference with a tilted fundamental Gaussian beam. Both amplitude and phase control can be utilized with this exemplary device. The image on the left (FIG. 7a) is taken at a distance where the two beams cross each other and interfere, forming a fork-shaped stripe pattern. In the center region of this pattern, two new stripes are formed, which comports with the designed orbital angular momentum number of the vortex beam. The image on the right (FIG. 7b) is taken at a larger distance where the two beams separate from each other, where the donut-shaped Vortex beam can be distinguished from the tilted fundamental Gaussian beam.

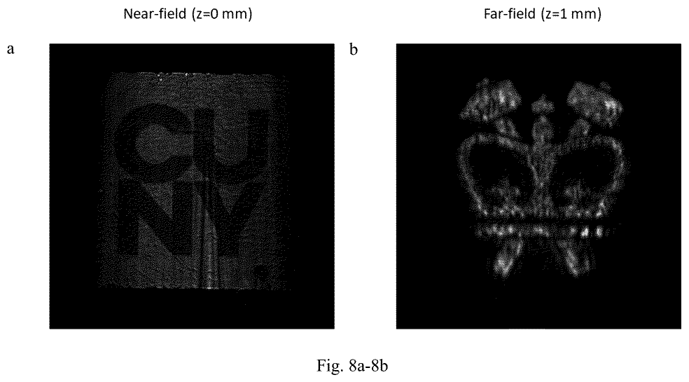

FIG. 8a-8b illustrates an exemplary 2-Hologram demonstration. The amplitude profile displays an image pattern in the near-field as shown in FIG. 8a, while another image is encoded in the phase profile to show in the far-field as shown in FIG. 8b. FIG. 8a shows the near-field intensity distribution of this device, which is designed to display a logo; FIG. 8b shows the far-field intensity at a distance of 1 mm, which is designed to display another logo.

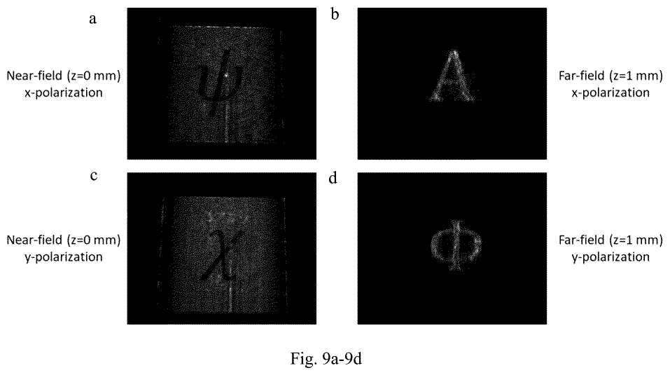

FIG. 9a-9d illustrates an exemplary demonstration of a 4-Hologram. The x and y polarization components can be configured as two independent channels, each generating an image in the near-field and another image in the far-field. The two images on the left are the near-field intensities of the two polarization components as shown in FIG. 9a and FIG. 9c, which are designed to display the Greek letters psi and chi, respectively. The two images on the right are the far-field intensities of the two polarization components as shown in FIG. 9b and FIG. 9d, which are designed to display the letters A and Phi, respectively. Through the effective display of these four letters simultaneously using the four channels, integrated metasurfaces are able to control all the four optical degrees of freedom of a monochromatic wavefront.

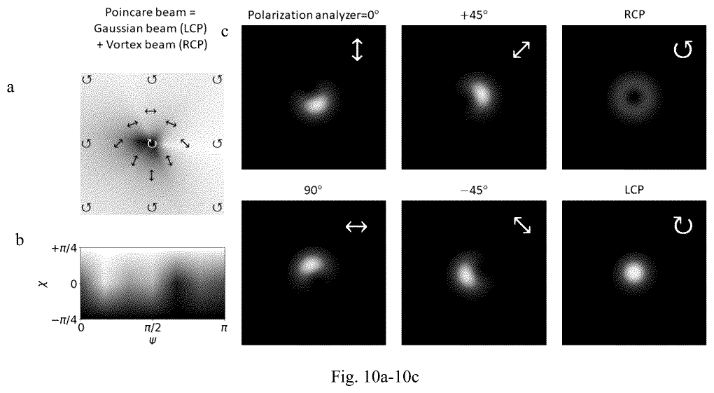

FIG. 10a-10d illustrates an exemplary demonstration of generating a Poincare beam, which is represented as a superposition of a fundamental Gaussian beam and a vortex beam of orthogonal polarizations, as shown in FIG. 10a. This complex vectoral beam covers all the 2-dimensional polarization states on a corresponding wavefront. The colorplot with a 2D colormap shows the designed polarization profile, as shown in FIG. 10b. This polarization profile can be revealed by imaging the wavefront through the six polarization analyzer settings, as shown in FIG. 10c. These six polarization images of FIG. 10c. comport with the theoretical patterns thereof.

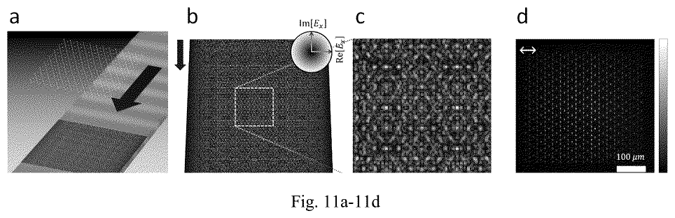

FIG. 11a-11d illustrates an exemplary demonstration of the generation of a two-dimensional array of optical spots following a Kagome lattice pattern. FIG. 11a is a schematic of the Kagome lattice generator based on the complex near field in FIG. 11b; the central region of this field is shown in FIG. 11c. FIG. 11d is the measured holographic lattice at a plane z=0.5 mm away from the device surface. All devices generate y-polarized light, except for the Kagome lattice generator, which produces x-polarized surface emission.

Based on the above demonstration, the present subject matter discloses an integrated metasurface devices and/or methods that converts a waveguide mode into an arbitrarily-shaped free-space wavefront, with control over amplitude, phase and polarization. The working principles are based on symmetry-breaking perturbation behaviors, and can be applicable to other materials platforms and wavelengths. By placing meta-unit arrays in the vicinity of waveguides, integrated metasurfaces can achieve the function of guided mode conversion, free-space to guided mode coupling, or free-space wavefront generation. With the advantage of connecting the free-space channel and the integrated channel, integrated metasurfaces, as in the presently disclosed subject matter, can have many prospective applications, such as AR/VR display and wearable photonics, chip-to-free-space communications, and quantum optics, where integrated metasurfaces can help reduce the dimension and complexity of a quantum optics setup.

In addition to the various embodiments depicted and claimed, the disclosed subject matter is also directed to other embodiments having other combinations of the features disclosed and claimed herein. As such, the particular features presented herein can be combined with each other in other manners within the scope of the disclosed subject matter such that the disclosed subject matter includes any suitable combination of the features disclosed herein. The foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the systems and methods of the disclosed subject matter without departing from the spirit or scope of the disclosed subject matter. Thus, it is intended that the disclosed subject matter include modifications and variations that are within the scope of the appended claims and their equivalents.

What we claim is:

1. An integrated metasurface device for conversion between a waveguide mode and a free-space optical wave with a designer wavefront, comprising:
a) a thin waveguide;
b) a waveguide taper;
c) a leaky-wave metasurface defined within a high refractive index layer of dielectric material; and
d) a low refractive index substrate, the high refractive index layer depositing thereon.

2. The integrated metasurface device of claim 1, wherein the thin waveguide supports a waveguide mode.

3. The integrated metasurface device of claim 1, wherein the waveguide taper converts the waveguide mode into a slab waveguide mode in the form of a sheet of light.

4. The integrated metasurface device of claim 1, wherein the leaky-wave metasurface comprises a plurality of meta-units.

5. The integrated metasurface device of claim 4, wherein each meta-unit comprises two sets of anisotropic meta-atoms, and wherein:
a) the two sets have a subwavelength offset between each other;
b) the two sets have different magnitudes of perturbation; and/or
c) the two sets have different orientations of perturbation.

6. The integrated metasurface device of claim 1, wherein the slab waveguide mode is decomposed into two orthogonal standing waves, wherein the two sets of meta-atoms independently control the two standing waves, converting each standing wave into a surface emission with independent amplitude and polarization orientation, and wherein the two surface emissions merge into a single free-space wave with completely and independently controllable amplitude, phase, polarization orientation, and polarization ellipticity at each point over the wavefront of the free-space wave.

7. The integrated metasurface device of claim 1, wherein the high refractive index layer comprises one or more layers, and the leaky-wave metasurface is defined therein.

8. The integrated metasurface device of claim 5, wherein the meta-atoms are ellipse-shaped, the magnitude of perturbation is the ellipticity of the ellipse, and the orientation of perturbation is the angular orientation of the ellipse.

9. The integrated metasurface device of claim 5, wherein the meta-atoms are rectangle-shaped, the magnitude of perturbation is a ratio between the long and short edges of the rectangle, and the orientation of perturbation is angular orientation of the rectangle.

10. The integrated metasurface device of claim 5, wherein the meta-atoms are air apertures etched in the high refractive index layer.

11. The integrated metasurface device of claim 5, wherein the meta-atoms are dielectric pillars etched in the high refractive index layer.

12. The integrated metasurface device of claim 1, wherein the high refractive index layer comprises silicon, silicon nitride, silicon-rich silicon nitride, titanium dioxide, SU-8, and polymethyl methacrylate (PMMA), and wherein the low refractive index substrate comprises silicon dioxide, calcium fluoride, and magnesium fluoride.

13. A method for converting a waveguide mode into a free-space optical wave with a designer wavefront, comprising:
a) converting the waveguide mode into a slab waveguide mode using a waveguide taper;
b) coupling the slab waveguide mode into a leaky-wave metasurface;
c) decomposing the slab waveguide mode within the leaky-wave metasurface into two orthogonal standing waves that are 90-degree out of phase;
d) using two sets of meta-atoms of the leaky-wave metasurface to independently convert the two orthogonal standing waves into two surface emissions with independently controllable amplitude and polarization orientation; and
e) merging the two surface emissions into a single free-space wave with completely and independently controllable amplitude, phase, polarization orientation, and polarization ellipticity at each point over the wavefront of the free-space wave.

14. A method for converting a free-space optical wave with a designer wavefront into a waveguide mode, comprising:
a) decomposing a free-space wave into two free-space components that are 90-degree out of phase;
b) using two sets of meta-atoms of the leaky-wave metasurface to independently convert the two free-space components into two orthogonal standing waves that are within the leaky-wave metasurface;
c) combining two orthogonal standing waves into a slab waveguide mode; and
d) coupling the slab waveguide mode into a waveguide mode using a waveguide taper.

15. A method of using an integrated metasurface device of claim 1 for free-space wavefront generation, comprising:
a) exciting an integrated metasurface device with a waveguide mode; and
b) establishing at least one of the following free-space wavefronts:
a. a free-space wave with a designer polarization state, including circular polarization, radial polarization, and azimuthal polarization;
b. a focused beam in free space;
c. a one-dimensional array of focal spots in free space;
d. a two-dimensional array of focal spots in free space;
e. a three-dimensional array of focal spots in free space;
f. a vortex beam with orbital angular momentum in free space;
g. one or more holographic images in free space; or
h. a Poincare beam in free space.

16. A utilization of an integrated metasurface device of claim 1, comprising incorporating the integrated metasurface device into AR/VR displays, wearable devices, optical communications chips, optogenetic probes, and quantum optics setups.
